(19) United States
(12) Patent Application Publication
(10) Pub. No.: US 2008/0040806 A1
(43) Pub. Date: Feb. 14, 2008

(54) METHOD AND APPARATUS FOR SECURING UNPROTECTED CONTENT FILES FROM UNAUTHORIZED USE

(75) Inventor: Michael D. Kotzin, Buffalo Grove, IL (US)

Correspondence Address: Motorola, Inc.;Law Department, 1303 East Algonquin Road, 3rd Floor, Schaumburg, IL, 60196, US

(73) Assignee: Michael D. Kotzin, Buffalo Grove, IL (US)

(21) Appl. No.: 11/463,201

(22) Filed: Aug. 8, 2006

(51) Int. Cl. H04L 9/32

(52) U.S. Cl. 726/26

(57) ABSTRACT

A method and apparatus are provided that check for the existence of a media player cracking tool that is used to sniff, or capture, unprotected content rendered by a media player that uses DRM protection. If a media player cracking tool is detected, the corresponding content file will not be decrypted.

### TECHNICAL FIELD OF THE INVENTION

The invention relates to a method and an apparatus for securing unprotected content files from unauthorized use.

### BACKGROUND OF THE INVENTION

The term “content” is used in the broadcast and communications industries to denote digital files and streamed information, such as, for example, video files (e.g., movies, video games, etc.), audio files (e.g., music, audio books, audio news articles, etc.), image files, text files, streaming audio data, and streaming video data. Content is distributed by a content provider to end users over wired and wireless networks to devices that have content renderers, such as media player programs, that render the content, e.g., display the content on a display device and/or playback the content on an audio playback device. For example, a cable television provider or multiple service operator (MSO) may allow a user (typically a paying customer) to download a movie that the user then watches on a laptop computer, a television set, a mobile telephone, etc. Similarly, an Internet online service may allow a user (typically a paying customer) to download content files, such as new articles, video games, music, etc., for playback or rendering by an appropriate media player or content rendering program.

Content providers manage the distribution of content (e.g., downloading, streaming, etc.) by using one or more of a variety of digital rights management (DRM) techniques. DRM techniques are used to prevent unauthorized users from gaining access to content while allowing authorized users to access the content. This is typically accomplished by encrypting the content when it is distributed to the authorized user, and providing the user with a key or keys, which allow the user's device to decrypt the content so that it can be rendered. DRM, however, encompasses more than securing content from unauthorized access. It also encompasses describing, identifying, trading, monitoring, and tracking of all forms of rights usages over both tangible and intangible assets. The term “tangible assets” refers to physical content, whereas the term “intangible assets” generally refers to copyrights in the content held by copyrights holders.

Once the content provider has distributed the content and the decrypting key to the user, the content becomes available to the user in unencrypted format. Once the content is in unencrypted format, it is difficult or impossible for the content provider to prevent illegal distribution of the content. While trusted platforms have been proposed to prevent access to the content in its unprotected form, such platforms are not universally employed and are not likely to become universally employed. People prefer their computing devices, such as personal computers (PCs) and laptops, to be highly versatile and flexible, and the predominant view in the industry is that employing a universal platform reduces the versatility and flexibility of computing devices.

The lack of a universally employed security platform or protection methodology for protecting unprotected content has made it possible for industrious ne'er-do-wells to create programs and tools that capture unprotected content, which is temporarily in its unencrypted, unprotected state, thus facilitating unauthorized distribution, copying and/or rendering of the content. The programs or tools that are used to capture unencrypted content are often referred to as “cracking” or “sniffing” software programs. Cracking programs “sniff” the unencrypted content while it is in “transition” between the decryption process and the rendering process. Cracking programs work by allowing a user to surreptitiously obtain the decryption keys and subsequently use those keys to decrypt content.

Virus and spyware detection and protection programs are available that search for cracking programs on hard drives of computers and other devices that render content. If a cracking program is detected, the user is notified and given the ability to block or remove the cracking program. For example, FIG. 1 illustrates a screen that is displayed to a user on a computer display monitor after a spyware protection program sold by America Online (AOL) Corporation has performed a full hard disk scan and detected the existence of a cracking program called “FreeME” . The FreeME program is a tool that is used to decrypt Microsoft Windows Media content protected with Microsoft Corporation's Windows Media DRM. The AOL Spyware protection program informs the user when cracking tools such as FreeME are found and gives the user the ability to block or remove these tools.

Some networked computer game programs include code that looks for hacking programs that are used to improperly provide playing advantages to the game program. For example, the multiplayer computer game program “World of Warcraft” by Blizzard Entertainment includes a scan routine that scans the user's computer or other device and determines whether hacking is occurring. If the scan program detects that hacking is occurring, the user's account to access the game is terminated.

Currently, no tools exist that detect the existence of a cracking tool that can be used to sniff unencrypted content rendered by a media player program. Accordingly, a need exists for a tool that detects the existence of a cracking tool that can be used to sniff unencrypted content being rendered by a media player program that employ DRM techniques. A need also exists for a tool that detects the existence of a cracking tool that can be used to sniff unencrypted content being rendered by a media player program and that prevents the media player program from decrypting the content if a cracking tool is detected.

### SUMMARY OF THE INVENTION

The invention provides a method and an apparatus for securing unprotected content files from unauthorized use. The apparatus comprises a user device comprising at least a first memory device, a decryption component configured to decrypt content files, and at least a first processor. The first processor is configured to perform a scan algorithm that scans a computational device of the apparatus to detect the existence of one or more tools used to capture unencrypted content to be rendered by a media player. If the processor detects the existence of one or more such tools, the processor prevents a requested content file from being decrypted by the decryption component.

The method comprises performing a scan algorithm that scans an apparatus and determines whether an one or more tools exist on the apparatus that are used to capture unencrypted content rendered by a media player. If a determination is made that one or more such tools have been detected, the content file will not be decrypted.

These and other features and advantages of the invention will become apparent from the following description, drawings and claims.

### BRIEF DESCRIPTION OF THE DRAWINGS

FIG. 1 illustrates a screen shot that is displayed by a known computer program to indicate to a user that a cracking program has been detected.

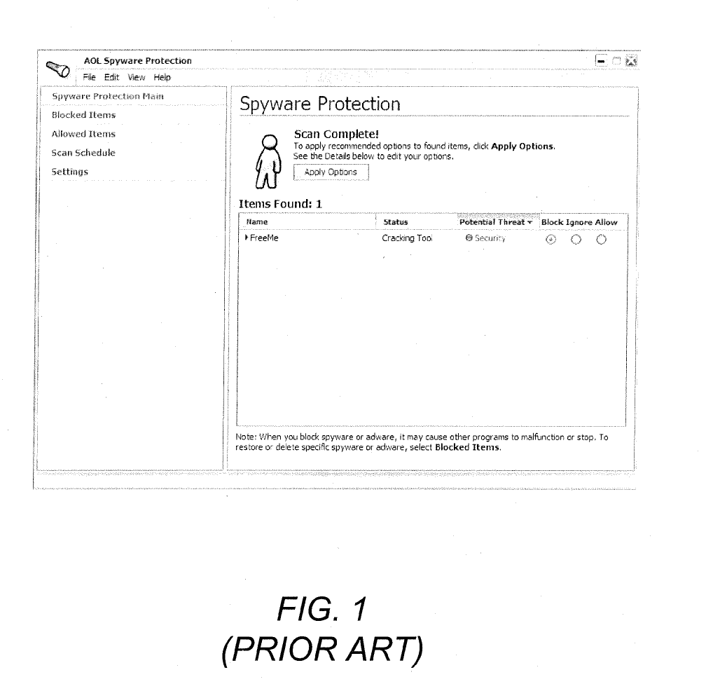

FIG. 2 illustrates a flowchart that represents the method of the invention in accordance with an exemplary embodiment for determining whether a media player cracking tool exists, and if so, preventing a content file from being decrypted.

FIG. 3 illustrates a flowchart that represents the method of the invention in accordance with an exemplary embodiment for checking for the existence of a media player cracking tool.

FIG. 4 illustrates a flowchart that represents the method of the invention in accordance with an exemplary embodiment for preventing or allowing a content file to be decrypted depending on whether or not the existence of a cracking tool is detected by the method described with reference to FIG. 3.

FIG. 5 illustrates a block diagram of the apparatus of the invention in accordance with an exemplary embodiment for carrying out the methods represented by FIGS. 3 and 4.

FIG. 6 illustrates a flowchart that represents an exemplary embodiment of the method of the invention for performing a checking algorithm 100 that checks when the scan algorithm was last performed and inhibits normal operation of a media rendering tool if the scan algorithm was not performed sufficiently recently in time.

### DETAILED DESCRIPTION OF EXEMPLARY EMBODIMENTS

In accordance with the invention, a method and apparatus are provided that check for the existence of a cracking tool that is used to sniff unprotected content rendered by a media player that uses DRM protection. If a media player cracking tool is detected, the corresponding media player program will not allow the content file to be decrypted. These goals of the invention may be accomplished in a variety of ways, as will now be described below with reference to a few exemplary embodiments.

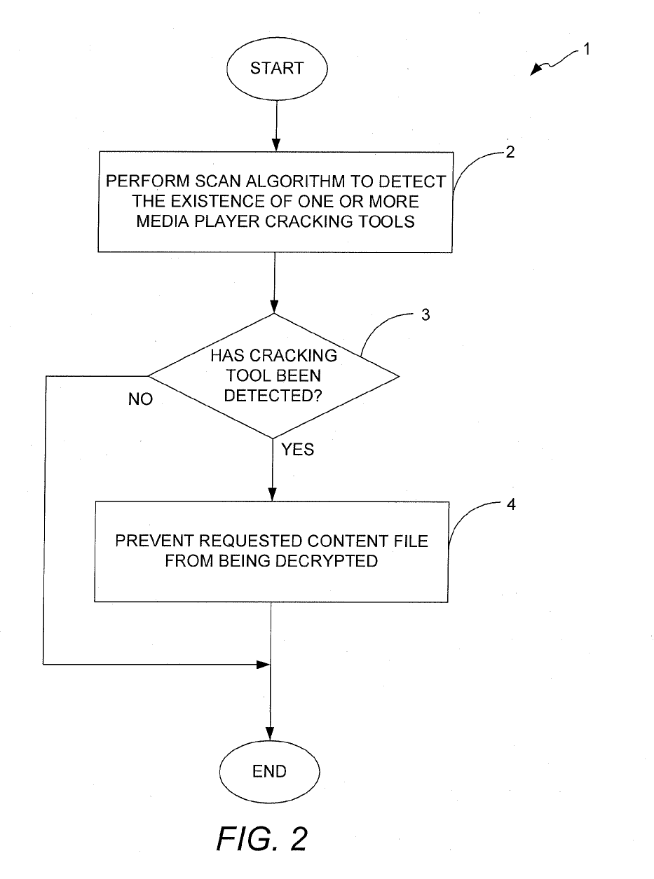

FIG. 2 illustrates a flowchart that represents the method 1 of the invention for determining whether one or more cracking tools exist on a device that sniff, i.e., capture, unencrypted content to be rendered by a media player, and if so, preventing the content file from being decrypted. A scan algorithm is executed that detects if one or more cracking tools exist on the device, as indicated by block 2. A determination is made as to whether one or more media player cracking tools has been detected, as indicated by block 3. If one or more cracking tools is detected, a requested content file is prevented from being decrypted, as indicated by block 4.

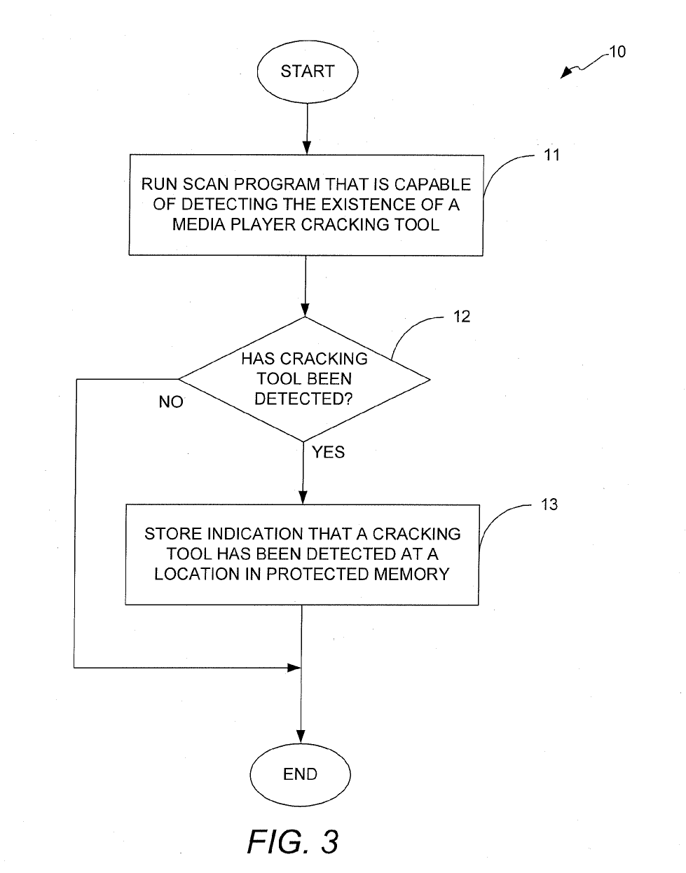

FIG. 3 illustrates a flowchart that represents the method 10 of the invention in accordance with an exemplary embodiment for detecting a media player cracking tool and storing an indication that such a tool has been detected in protected memory. In accordance with an embodiment of the invention, a scan program runs on a PC, laptop, telephone, personal digital assistant (PDA), or other computational device on which the media player program is installed. The scan algorithm detects if a cracking tool exists that is capable of sniffing unencrypted content as it is rendered by a media player, as indicated by block 11. A determination is made as to whether a cracking tool has been detected, as indicated by block 12. If so, an indication that a cracking tool has been detected is stored in a location in protected memory, as indicated by block 13. If not, the process ends. As will now be described, this protected memory is read prior to a media program decrypting content, and if an indication is contained in the protected memory, the media program will not decrypt the content.

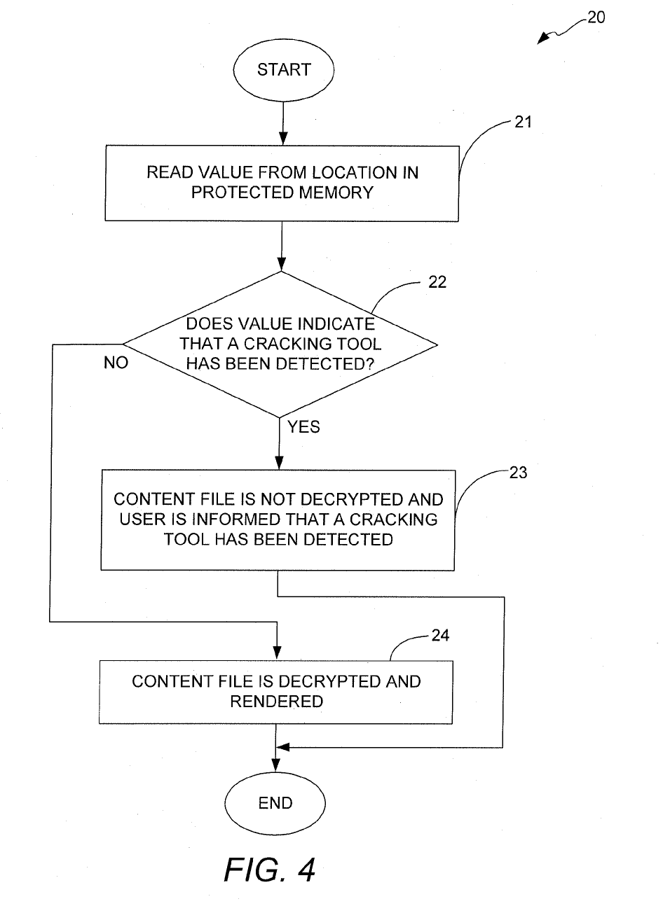

FIG. 4 illustrates a flowchart that represents the method 20 of the invention in accordance with an exemplary embodiment for preventing a media player program from decrypting and rendering content if protected memory contains an indication that a cracking tool has been detected. In accordance with this exemplary embodiment, when a media player program is invoked to render a content file, the media player program reads a value stored at a location in protected memory, as indicated by block 21. The media player program determines whether the value indicates that the existence of a cracking program has been detected, as indicated by block 22. If so, the media player program does not decrypt the content file and preferably provides an indication to the user that a cracking tool exists on the computational device and that content will not be rendered, as indicated by block 23. If a determination is made at block 22 that the value read from protected memory does not indicate that a cracking tool has been detected, the content file is decrypted and rendered, as indicated by block 24.

The protected memory referred to above with reference to FIGS. 3 and 4 may be any memory device that is accessible by the computational device that executes the scan algorithm of the invention. An important aspect of the memory device that is used for this purpose is that it is protected in some manner to prevent the user or some other person or entity from being able to access the memory location in which the indication is stored. This feature of the invention prevents a person from being able to alter the indication in order to enable a cracking program to sniff unencrypted contents. One suitable memory device for this purpose is a memory element contained on a Subscriber Identity Module (SIM) integrated circuit (IC) of the type typically contained on a SIM card installed in a wireless telephone. A SIM IC is a hardware platform that cannot be easily altered or hacked, and the user typically cannot directly access the SIM IC.

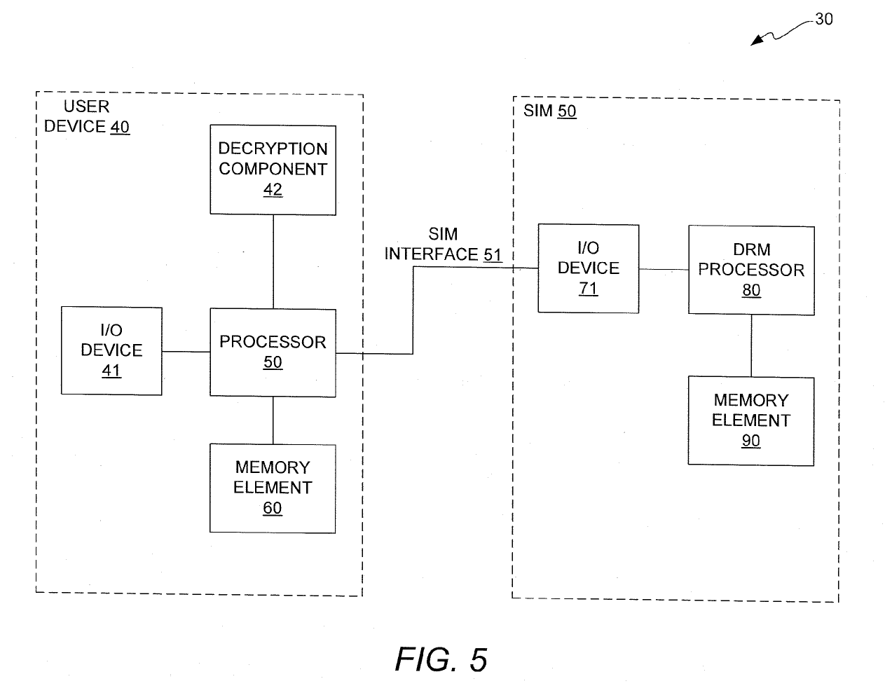

FIG. 5 illustrates a block diagram of the apparatus 30 of the invention, in accordance with an exemplary, which is suitable for implementing the methods of the invention. The apparatus 30 is typically some type of computational device having content rendering capabilities such as, for example, a PC a laptop or notebook computer, a wireless telephone, a PDA, etc. The apparatus 30 includes a user device 40 and a SIM IC 70. The user device 40 and the SIM IC 70 communicate with each other via a SIM interface 51. The user device 40 includes an input/output (I/O) device 41, a processor 50, a memory device 60, and a decryption component 42. The SIM IC 70 includes an I/O device 71, a processor 80 and a memory device 90. The processor 50 of the user device 40 performs the scan algorithm of the invention described above with reference to FIG. 3. The algorithm described above with reference to FIG. 4 may be performed by the processor 50 of the user device 40 or by the processor 80 of the SIM IC 70, or partially by processor 50 and partially by processor 80, as will be described below in more detail.

The I/O device 41 receives encrypted content files and the associated decryption keys from a service provider (not shown). The encrypted content files are stored by the processor 50 in memory device 60. The decryption keys may be stored in memory device 60 of the user device 40 or in memory device 90 of the SIM IC 70. For purposes of describing the principles and concepts of the invention, it will be assumed that the decryption keys are stored in memory device 90 of the SIM IC 70 so that it is extremely difficult or impossible for a user to access the decryption keys. The decryption component 42 uses the keys to decrypt content files to enable the content files to be rendered by a rendering software or hardware component (not shown).

The apparatus 30 operates as follows when performing the scan algorithm described above with reference to FIG. 3. The processor 50 performs the scan algorithm described above with reference to FIG. 3 at any time before the decryption component 42 decrypts a content file. In accordance with one exemplary embodiment of the invention, the scan algorithm is performed every time content is brought into the user device 40 and/or every time a new program is installed on the user device 40 and/or every time a program is executed by the user device 40. In accordance with another exemplary embodiment, the scan algorithm is performed at periodic time intervals to ensure that the most recent scan was performed relatively recently and that the indication stored in memory has been updated relatively recently. The indication stored in memory may be in the form of a scan definition file that contains names/indicia/signatures of the cracking or sniffing programs.

Whenever the processor 50 detects the existence of a cracking program, the processor 50 sends an indication via SIM interface 51 to SIM IC 70. The processor 80 receives the indication via I/O device 71 and stores the indication at a location in memory device 90. In accordance with another embodiment, the scan algorithm is only performed when the processor 50 receives a user request to render a content file stored in memory device 60. In either case, whenever the processor 50 detects the existence of a cracking program, the processor 50 sends an indication via SIM interface 51 to SIM IC 70. The processor 80 receives the indication via I/O device 71 and stores the indication at a location in memory device 90. As stated above, the indication may instead be stored in memory device 60 of the user device 40, but this may not be as secure as storing the indication in memory device 90 of the SIM IC 70.

In accordance with an exemplary embodiment, the apparatus 30 operates as follows when performing the algorithm described above with reference to FIG. 4. The processor 50 receives a request to render a content file from a user of the user device 40. The processor 50 then sends a request via SIM interface 51 to the SIM IC 70 for the SIM processor 80 to send the key or keys needed to decrypt the content file, which triggers the SIM processor 80 to read the SIM memory device 90. The SIM processor 80 reads the memory device 90 and determines whether the value read indicates that a cracking program has been detected. If not, the processor 80 sends the corresponding key or keys to the processor 50 of the user device 40. The processor 50 receives the key and sends it and the content file retrieved from memory device 60 to the decryption component 42. The decryption component 42 uses the key to decrypt the content file and send the decrypted content to a media player (not shown), which renders the content.

If the processor 80 determines that the value read from memory device 90 indicates that the existence of a cracking program has been detected, the processor 80 sends a corresponding response to the processor 50. The processor 50 may then cause an indication of some type to be conveyed to the user that indicates that a cracking program has been detected and that the content file will not be rendered. The user may also be given the ability to remove the cracking program, and after the cracking program has been removed, the location in memory device 90 may be updated to indicate that the cracking program has been removed. Thus, if the user subsequently requests rendering of the content file, the key will be sent to the processor 50 to allow the content file to be decrypted and rendered.

The protected memory location or locations in which the indication that a cracking tool has been detected is stored may be contained in memory device 60 of the user device 40 instead of in memory device 90 of the SIM 50. In this case, prior to the processor 50 requesting the decryption key from the SIM 50, the processor 50 may first read the value stored in the protected memory location in memory device 60. If the value indicates that a cracking tool has been detected, the processor 50 will not request the key. If the value indicates that a cracking tool has not been detected, the processor 50 will request the key. As will be understood by those skilled in the art, in view of the description provided herein, a variety of scenarios exist for carrying out the methods represented by the flowchart shown in FIG. 4.

Regardless of the memory device is used as the protected memory for storing the indications (e.g., memory devices 60 or 90), the locations at which the indications are stored may be changed periodically to another known location to make it even more difficult for a user to access and alter the indications in an attempt to bypass the security provided by the invention. As stated above, storing the indications in SIM memory device 90 make it extremely difficult or impossible for a user to access and alter the indications. Thus, the memory location can be “protected” using one or more of these and/or other techniques.

The processors 50 and 80 may be any type of computational devices that are suitable for performing the functions described above with reference to FIGS. 2-5, including, for example, a microprocessor, a microcontroller, an application specific integrated circuit (ASIC), a programmable gate array, etc. The processors may be implemented solely in hardware or in a combination of hardware and software or firmware. In the case where the processors are implemented in a combination of hardware and software or firmware, the software programs executed by the processors are typically stored in the associated memory devices 60 and 90. The memory devices 60 and 90 are typically solid-state devices integrated with the processors 50 and 80, respectively, on the same IC. The memory devices 60 and 90 may be any type of computer-readable mediums such as, for example, random access memory (RAM), dynamic RAM (DRAM), flash memory, read only memory (ROM), compact disk ROM (CD-ROM), digital video disks (DVDs), magnetic disks, magnetic tapes, etc. The invention also encompasses electrical signals modulated on wired and wireless carriers (e.g., electrical conductors, wireless carrier waves, etc.) in packets and in non-packet formats.

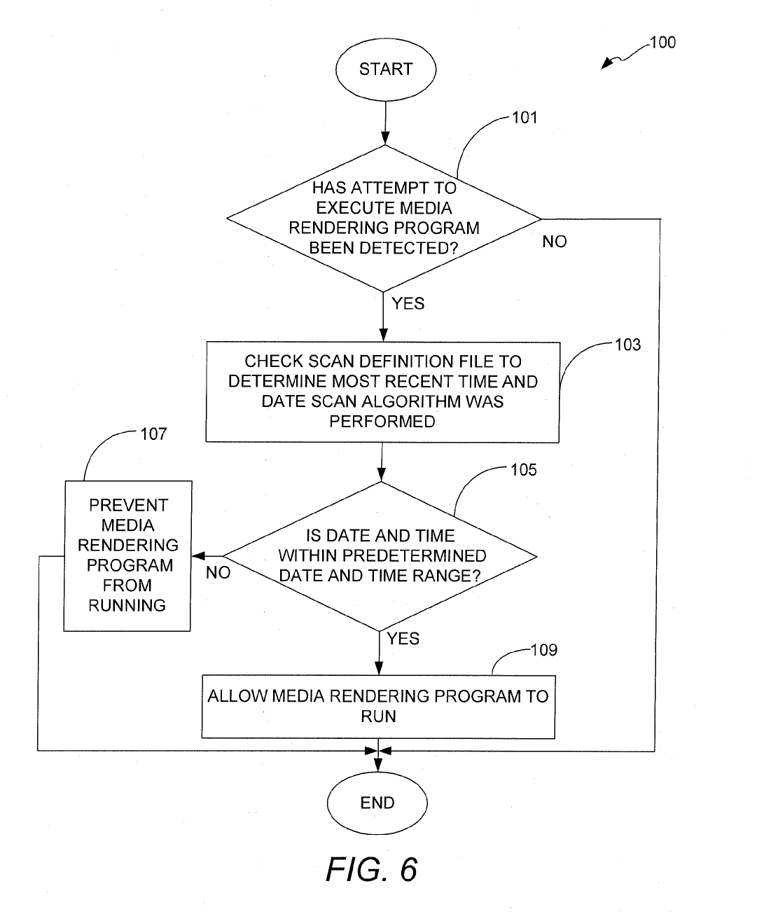

FIG. 6 illustrates a flowchart that represents an exemplary embodiment of the method of the invention for performing a checking algorithm 100 that checks when the scan algorithm was last performed and inhibits normal operation of a media rendering tool if the scan algorithm was not performed sufficiently recently in time. In accordance with this exemplary embodiment, it is assumed that performance of the checking algorithm is triggered by an attempt to execute a media rendering tool. It should be noted, however, that the checking algorithm may be performed at anytime.

The checker algorithm 100 will typically be implemented in the form of a software program that is stored in memory device 60 and executed by processor 50. As shown in FIG. 6, when the checker program runs, a determination is made as to whether an attempt to execute a media rendering program has been detected, as indicated by block 101. If so, the aforementioned scan definition file is checked to determine the latest date and time that the scan algorithm was performed, as indicated by block 103. A determination is then made as to whether this date and time is within a predetermined date and time range, as indicated by block 105. If not, execution of the media rendering program is prevented, as indicated by block 107. If so, execution of the media rendering program is allowed, as indicated by block 109.

The invention has been described with reference to certain embodiments for the purpose of demonstrating the principles and concepts of the invention. It should be noted, however, that the invention is not limited to the embodiments described herein. As will be understood by those skilled in the art, many modifications can be made to the embodiments described herein, and all such modifications are within the scope of the invention.

What is claimed is:

1. An apparatus for securing unprotected content files from unauthorized use, the apparatus comprising:
a user device comprising:
at least a first memory device;
a decryption component configured to decrypt content files; and
at least a first processor configured to perform a scan algorithm that scans a computational device of the apparatus to detect an existence of one or more tools used to capture unencrypted content to be rendered by a media player, wherein if the processor detects the existence of one or more of said tools, the processor prevents a requested content file from being decrypted by the decryption component.

2. The apparatus of claim 1, wherein if the processor detects the existence of one or more of said tools, the processor causes an indication that the existence of one or more of said tools has been detected to be stored in a protected memory location in the first memory device, wherein the protected memory location corresponds to one or more addresses in the first memory device of the apparatus.

3. The apparatus of claim 2, wherein when a content file is requested, the processor reads a value stored in the protected memory location and determines whether the value corresponds to an indication that one or more of said tools have been detected, wherein if the processor determines that the value corresponds to an indication that one or more of said tools have been detected, the processor prevents the requested content file from being decrypted.

4. The apparatus of claim 3, wherein if the processor determines that the value corresponds to an indication that one or more of said tools have been detected, the processor causes a message to be conveyed to a user of the apparatus to inform the user that one or more of said tools have been detected.

5. The apparatus of claim 4, wherein the message that is conveyed to the user also informs the user with information regarding how the detected tool or tools can be removed from the apparatus, wherein if the user removes the detected tool or tools from the apparatus, the processor causes the value stored in the protected memory location to be changed to indicate that one or more of said tools have not been detected.

6. The apparatus of claim 1, further comprising:
a subscriber identity module (SIM) integrated circuit (IC) comprising:
a SIM interface configured to provide a communications channel between the user device and the SIM;
at least a second memory device, the second memory device storing one or more keys for decrypting content files; and
at least a second processor configured to retrieve one or more decrypting keys associated with a particular content file from the second memory device, the second processor being capable of causing the key or keys to be sent to the user device via the SIM interface, the first processor receiving a key or keys sent to the user device via the SIM interface, the first processor causing the key or keys received via the SIM interface to be sent to the decryption component if the first processor fails to detect the existence of one or more of said tools, the decryption component using the received key or keys to decrypt an associated content file.

7. The apparatus of claim 6, wherein if the first processor detects the existence of one or more of said tools, the first processor causes an indication that the existence of one or more of said tools has been detected to be sent to the SIM IC via the SIM interface, the second processor causing the indication to be stored in a protected memory location in the second memory device, wherein the protected memory location corresponds to one or more addresses in the second memory device.

8. The apparatus of claim 7, wherein when a content file is requested, the first processor sends a request to the second processor via the SIM interface that causes the second processor to read a value stored in the protected memory location and determine whether the value corresponds to an indication that one or more of said tools has been detected, wherein if the second processor determines that the value indicates that one or more of said tools has been detected, the second processor sends a message to the first processor via the SIM interface indicating that the value stored in the protected memory location indicates that one or more of said tools has been detected.

9. The apparatus of claim 8, wherein if the second processor determines that the value stored in the protected memory location indicates that one or more of said tools has been detected, the second processor prevents the key or keys associated with the requested content file from being sent to the user device.

10. The apparatus of claim 2, wherein the first processor is also configured to perform a checker algorithm that checks said indication stored in protected memory to determine when the scan algorithm was most recently performed, and wherein if the first processor determines that the most recent performance of the scan algorithm did not occur sufficiently recently, the first processor prevents a media rendering tool from being used by the user device.

11. A method for securing unprotected content to be rendered by a media player, the method comprising:
performing a scan algorithm that scans an apparatus and determines whether an one or more tools exist on the apparatus that are used to capture unencrypted content rendered by a media player; and
if a determination is made that one or more of said tools have been detected, storing an indication that one or more of said tools has been detected in a protected memory location of a memory device, the protected memory location corresponding to one or more addresses of the memory device.

12. The method of claim 11, further comprising:
reading a value stored in the protected memory location;
determining whether or not the value read from the protected memory location indicates that one or more of said tools has been detected;
if a determination is made that the value read from the protected memory location indicates that one or more of said tools has been detected, preventing a requested content file from being decrypted; and
if a determination is made that the value read from the protected memory location indicates that one or more of said tools has not been detected, causing a requested content file to be decrypted.

13. The method of claim 12, further comprising:
if a determination is made that the value read from the protected memory location indicates that one or more of said tools has been detected, causing an indication that said one or more tools has been detected to be provided to a user.

14. The method of claim 11, further comprising:
periodically changing the address or addresses corresponding to the protected memory location.

15. The method of claim 11, wherein the protected memory location corresponds to one or more addresses in a memory device of a Subscriber Identity Module (SIM) integrated circuit (IC).

16. The method of claim 15, wherein the memory device of the SIM IC also has keys stored therein that are used to decrypt content files, the method further comprising:
if a determination is made that the value read from the protected memory location indicates that one or more of said tools has not been detected, causing a key or keys associated with a requested content file to be retrieved from the memory device and forwarded to a decryption component to enable the decryption component to decrypt the requested content file.

17. The method of claim 15, wherein the memory device of the SIM IC also has keys stored therein that are used to decrypt content files, the method further comprising:
if a determination is made that the value read from the protected memory location indicates that one or more of said tools has been detected, preventing a key or keys associated with a requested content file from being forwarded to a decryption component to thereby prevent the decryption component from being able to decrypt the requested content file.

18. The method of claim 2, further comprising:
performing a checker algorithm that checks said indication read from protected memory to determine when the scan algorithm was most recently performed; and
if a determination is made that the most recent performance of the scan algorithm did not occur sufficiently recently, preventing a media rendering tool from being used by the user device.

19. A computer program for securing unprotected content to be rendered by a media player, the program being stored on a computer-readable medium, the program comprising:
instructions for performing a scan algorithm that scans an apparatus and determines whether one or more tools exist on that apparatus that are used to capture unencrypted content rendered by a media player; and
instructions for storing an indication that one or more of said tools has been detected in a protected memory location of a memory device if a determination is made that one or more of said tools have been detected, the protected memory location corresponding to one or more addresses of the memory device.

20. The computer program of claim 19, further comprising:
instructions for reading a value stored in the protected memory location;
instructions for determining whether or not the value read from the protected memory location indicates that one or more of said tools has been detected;
instructions for preventing a requested content file from being decrypted if a determination is made that the value read from the protected memory location indicates that one or more of said tools has been detected; and
instructions for causing a requested content file to be decrypted if a determination is made that the value read from the protected memory location indicates that one or more of said tools has not been detected

21. The computer program of claim 20, further comprising:
instructions for causing an indication that said one or more tools has been detected to be provided to a user if a determination is made that the value read from the protected memory location indicates that one or more of said tools has been detected.
